(19) United States
(12) Patent Application Publication
(10) Pub. No.: US 2005/0005295 A1
(43) Pub. Date: Jan. 6, 2005

(54) 2-Dimension channel coding system

(76) Inventor: Chu Hui-Ling, Taipei (TW)

Correspondence Address: LAW OFFICE OF LIAUH & ASSOC., 4224 WAIALAE AVE, STE 5-388, HONOLULU, HI, 96816, US

(21) Appl. No.: 10/600,924

(22) Filed: Jun. 19, 2003

(51) Int. Cl. H04N 5/44

(52) U.S. Cl. 725/59; 348/734

(57) ABSTRACT

A 2-dimension channel coding system re-organizes the contents channels from various sources, and encodes their access paths and sequence in a 2-dimension order to enhance users' convenience in TV channel selection. It consists of an input receiver to take instructions sent by a remote controller from a TV user, a micro-processor to process the instructions based on the programs stored in the memory to make decision on TV channel selection, a memory module, a LAN module as contents receiver from web system or internet, a tuner to receive broadcasting signals and a VGA display module for TV that takes the signals from tuner or LAN module and outputs to TV sets. The TV channels in this system consists of the directory code channels in the 1^{st} hierarchy and the folder code channels in the 2^{nd} hierarchy, thus comes the order in 2 dimensions.

### BACKGROUND OF INVENTION

This invention is a coding technique on TV channel organization, specially on a 2-dimension coding order and system.

Nowadays the computer technology is able to integrate the contents from wireless broadcasting, cabled broadcasting, and web systems, and then output to TV as separate channels, as many channels as we want. The number of channels is technically unlimited and the TV users may be confused. This invention is designed to re-organize the traditional channel arrangement and enhance the convenience in channel selection by TV users.

### SUMMARY OF THE INVENTION

This invention re-organizes the access paths and sequence of various contents channels, and make it into a “2-dimension channel coding system” to facilitate the identification and selection on TV channels by TV users who usually operating remote controllers. The major purpose of this invention is to provide a technique-integrated system, the 2-dimension channel coding system, to execute the re-organization of various channels in the 2-dimension order. Another purpose of this invention is to provide the method to organize the access path and sequence to each channel in a 2-dimension order. In this system, TV channels are arranged in 2 hierarchies, the directory code channels in the first hierarchy and the folder code channels in the 2^{nd} hierarchy, on which channels in the different hierarchies constitute their own dimensions against the traditional linear arrangement of TV channels numbered from channel 1 and up in only one dimension. The directory codes in the 1^{st} hierarchy are of fixed number of digits denoting major channels, and the folder codes in the 2^{nd} hierarchy are of non-fixed number of digits to denote the sub-channels within a directory code channels.

Other than the coding technique, the function modules of this invention consists of an input receiver, a micro-processor, a memory module, a LAN module, a tuner, and a VGA display module for TV. With the integration of coding technique and these function modules, this invention is able to take signals inputed from wireless broadcasting, cabled broadcasting, and web system, and then output to TV sets as separate channels. TV users are benefited from this invention in better identifying and selecting abilities over numerous TV channels.

### BRIEF DESCRIPTION OF THE DRAWINGS

FIG. 1 is the modular diagram of this 2-dimension channel coding system;

FIG. 2 is the structure of this 2-dimension channel coding system;

FIG. 3 is the data organization in the memory module.

### DETALIED DESCRIPTION OF PREFERRED EMBODIMENTS

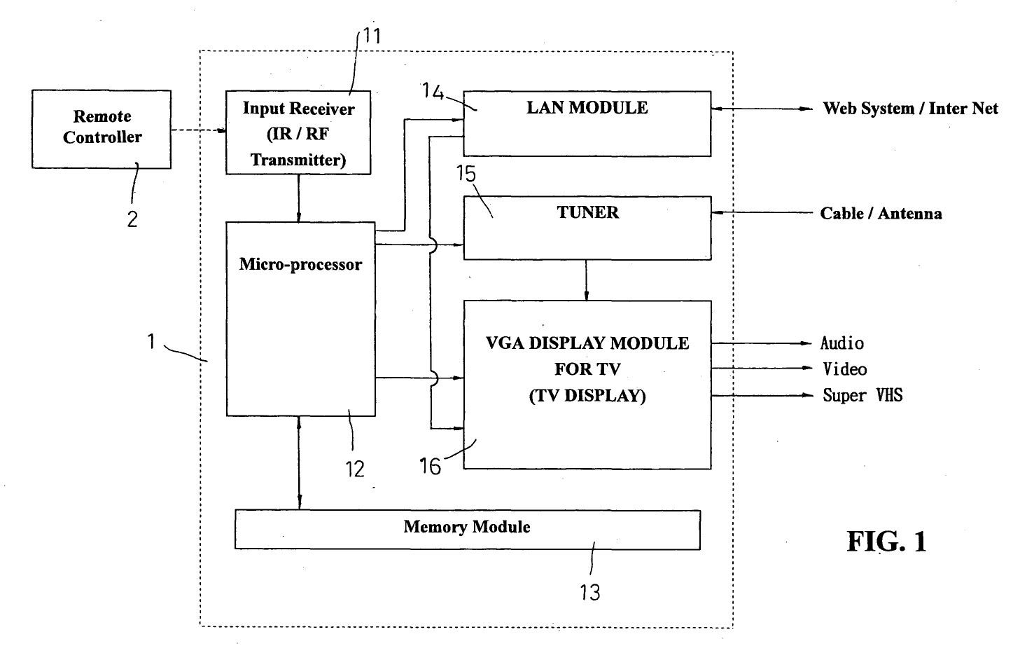

FIG. 1 is the modular diagram of this 2-dimension channel coding system, which consists of 6 function modules. Each of an electronic component readily available in the commercial market. They are:
1. Input Receiver 11. A module to receive input from TV user. Usually, it can't take input directly from human users, and all inputs are sent from a remote controller 2 operated by the user. Since most of the TV remote controller 2 send out signals by IR (Infrared Rays) or RF (Radio Frequency), input receiver 11 is often an IR/RF transmitter. All inputs received by this module will be transmitted to micro-processor 12 for further processing.
2. Micro-processor 12. A general purpose computer processor, like the central process unit made by Intel, AMD, Motorola or National Semiconductors, is sufficiently capable of being used here. In this system, micro-processor 12, based on the inputs received, runs the programs residing in the memory. The result will be the decision on selecting channels to be played.
3. Memory Module 13. General purpose memory chips of semiconductor for personal computers are used here, on which data and programs can be read, written, and stored. Memory communicates only with micro-processor, and its data organization shall be explained in detail.
4. LAN Module 14. It is a standard LAN chip or a LAN card used in personal computers for communicating with network or web system. Information received by LAN Module 14 will be transmitted to TV Display for output to TV.
5. Tuner 15. It is a standard tuner used in TV sets to select broadcasting channels and connected to cable terminal or antenna for input of signals. Signals received by tuner 15 is transmitted to TV Display for output to TV.
6. VGA Display Module for TV 16 (TV Display). This module is called “TV Display” for convenience. It takes input from LAN module 14 or tuner 15 and outputs to TV, with 3 output ports: audio, video, and super VHS. The traditional TV Display receives only input from TV tuner 15, which is the most common type used in TV sets. In this system, the output of LAN module 14 is also connected to TV Display which utilizes the technique of personal computer that outputs the LAN signals to a monitor. This TV Display could be a traditional one combined with a computer display module or a VGA module, or, the better way, made into an ASIC (Applied Special Integrated Circuits) to reduce its physical size.

All the function modules listed above can be implemented physically in a box, a card, or an ASIC (Applied Special Integrated Circuits) depending on the manufacturing technology used.

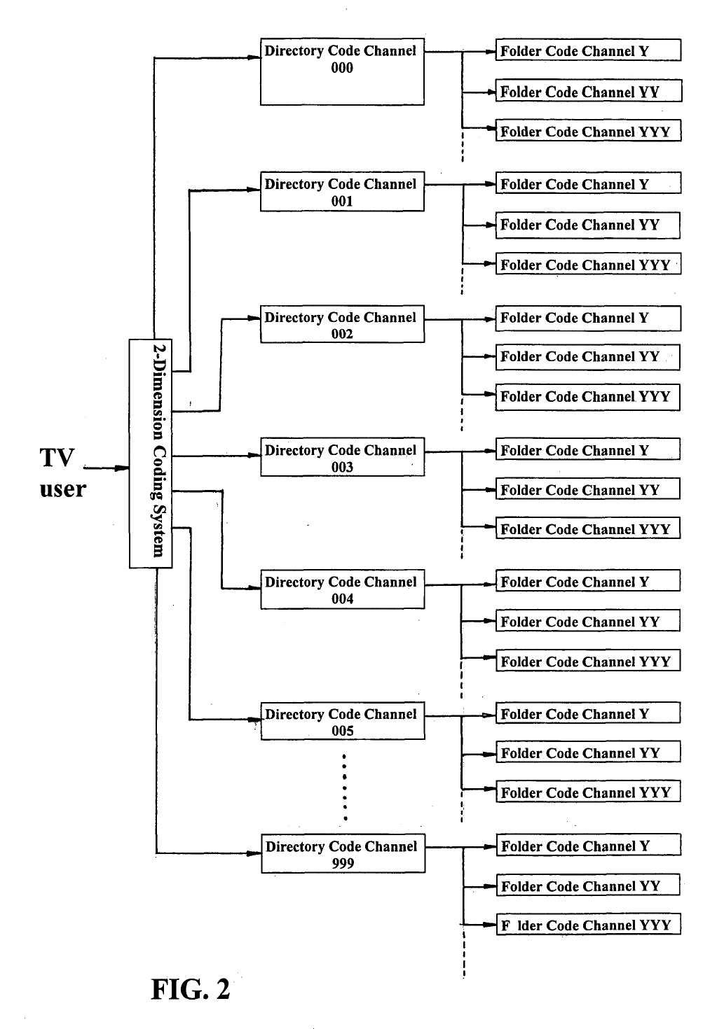

FIG. 2 is the structure of this 2-dimension channel coding system, showing access paths and sequence among channels.

This system organizes TV channel codes into 2 hierarchies, the directory codes of the 1st hierarchy, and the folder codes of the 2^{nd} hierarchy:

| Directory Code | Folder Code |
|---|---|
| XXX | YYY . . . |

Directory code: composed of 3 digits, i.e., 000, 001, 002, 003 up to 999.

Folder code: composed of arbitrarily assigned digits, i.e., 0, 01, 333 or 8888.

This coding system allocates total 1,000 TV channels in the 1^{st} hierarchy, each designated by its directory code. When the TV is playing a directory code channel, the channel designated by other directory code, no matter being from TV stations, RF broadcasting or websites, can be selected and viewed, that is, accessed, by:
1. Using the “Channel Up” and “Channel Down” functions.
2. Directly enter the directory code.

If there are channels designated by the folder codes within a directory code channel, a specific area in the TV or monitor screen will display these folder codes for selection by audience. This specific display area is usually called a “window”, though not necessarily in the shape of a window, because it contains contents different from its background—the screen. Folder code channels can be selected by means of:
1. “Up”, “Down”, “Right”, and “Left” function followed by “Enter” function, when a folder code window is shown on the screen.
2. When the TV is playing a folder code channel, directly entering the folder code under the same directory code.

When in a folder code channel, it can be switched to other folder code channels under the same directory code. It may not be switched directly to channels designated by other directory codes, or to folder code channels under other directory codes. In a folder code channel, it has to be switched back to its directory code channel and then a selection on other directory code channels can be made.

This system can be implemented on existing broadcasting system, web system and TV sets without changing any current industry structure. It also retains the habitual practice by TV users on switching TV channels.

The most common interface for TV users today, and also in foreseeable future, is the remote controller that used to operate TV set. In order to keep users' habitual practice on selecting TV channels, remote controller is used as the input interface in this implementation.

Not all the functions on the remote controller relate to the selection of channels. For example, volume control keys has nothing to do with channel selecting. The functions of the channel related inputs from remote controller are:
1. “Power”. To turn on or turn off the system. At the time the system is just turned on, it shows the channel played, no matter being directory code channel or folder code channel, while it was turned off last time.
2. “Channel Up” and “Channel Down”. To select the directory code channels by sequentially moving to the next or previous one to the currently played channel. They don't work on the channels of folder codes. If “Channel Up” and “Channel Down” are inputed when a folder code channel is played, there will be no change to the channel currently played and a sound or a beep signaling error is emitted to TV user's attention.
3. “Display”. This function key is dedicated to show the folder code window under current directory code channel. This window lasts on screen for n sounds (n is arbitrarily set by system builder) and will disappear automatically.
4. “aaa . . . ” (digits). A series of digits representing the code of a channel demanded by user, being either directory code or folder code.
When a directory code channel is played and there is no folder code window shown on screen, this input will be taken as the directory code and channel of that directory code will be selected.
When a directory code channel is played with its folder code window shown, this input is taken as the folder code under this directory code and this folder code channel will be selected. If it is not a valid folder code (that is, no folder code channel of the inputed “code” exists under current directory code) there will be no change to the channel currently played and a sound or a beep of error message is emitted to TV user's attention.
When a folder code channel is played, this input is taken as the folder code under the same directory code and this folder code channel will be selected. Again, if it is not a valid folder code, there will be no change to the channel currently played and an error message is sent.
5. “Back”. To returned to the current directory code channel from its folder code channel.

6. “Left”, “Right”, “Up”, “Down”. They are usually keys in triangle around the “Enter” key in the remote controller, used to move the cursor positioned on a folder code channel shown on the window. These four keys are only able to move the cursor while a window showing up; not able to switch to the folder code channel positioned without being followed by an “Enter” key.
7. “Enter”. This function key is used to confirm the selection on a folder code channel with a cursor positioned on when a folder code window is shown.

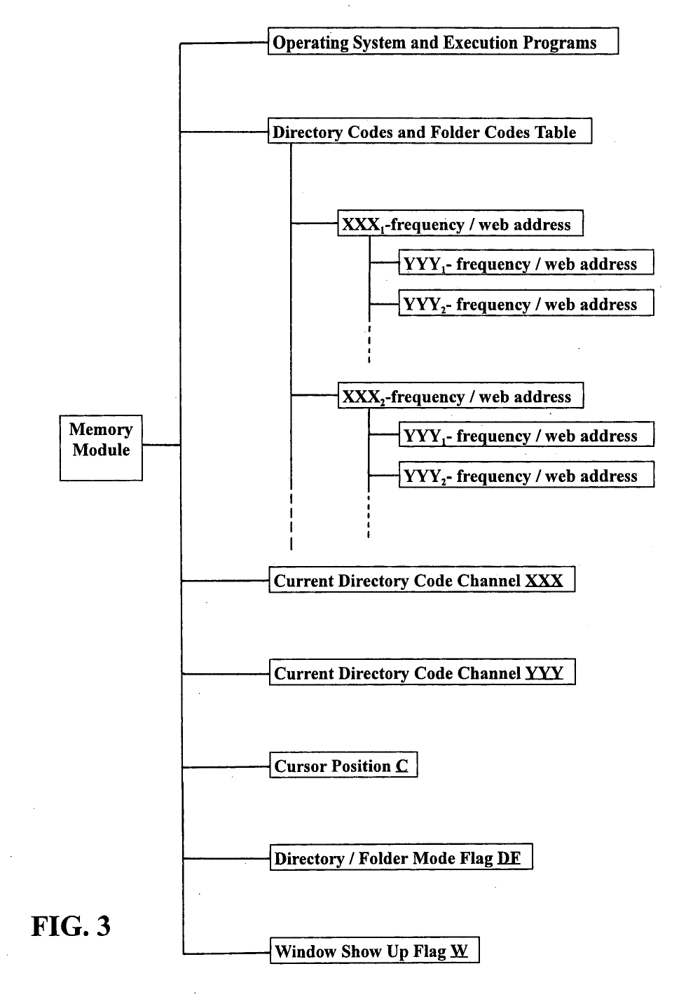

FIG. 3 is the data organization in the memory module. The programs and data needed to operate this system are stored in the memory. They are:
1. Operating system and execution programs. Operating system can be any commercial system like WinCE or Linux, or can be proprietary operating system specially developed. It offers a platform for user's program to be executed. The execution programs are working procedures written and coded on the platform of operating system, and they process inputs with reference to the data in the memory to make decision on the action of this system.
2. Directory code and folder code table. This table is a database containing all information about the valid channels. They are of three parts:
   a. All directory code channels and their frequencies at tuner or web address accessible through LAN module.
   b. All the folder code channels under every directory code channels.
   c. The frequency or web address of each folder code channel under a directory code.
3. Current Directory Code Channel XXX and Current Folder Code Channel YYY. We will call them Current Channel XXX and Current Channel YYY for convenience. XXX and YYY are parameters containing the code, always in digits, of currently played directory code channel and folder code channel respectively.
4. Cursor Position C. it is a parameter containing the folder code on which a cursor is placed when a folder code window is shown.
5. Directory/Folder Mode Flag DF. It is a parameter with its contents to be either “D” or “F”. “D” means that the channel now being played is a directory code channel, and “F” a folder code channel. When the Mode Flag DF is “D”, the selection on other directory code channel or the folder code channels under Current Channel XXX is possible. When the Mode Flag DF is “F”, only selection on other folder code channels under the same Current Channel XXX is possible, and any selection on other directory code channel can only be done after returning to its directory code channel by entering “Back” key.
6. Window Show Up Flag W. It is a parameter with its contents to be either “Yes” or “No”. W is set to “Yes” when a folder code window is shown on the screen of a TV or monitor, and set to “No” when a window is erased after its duration.

To accomplish the operation of this system, micro-processor will perform different procedures according to the input, and these procedures are written and coded on the platform of the operating system. Each procedure can be further breakdowned into basic actions to be executed by micro-processor, and many of these basic actions in different procedures are in common. Therefore, we can abstract these basic actions, calling them executions, and use them to construct procedures. Both the executions and procedures are general logic that can implemented on different platforms, that is, they are independent of platforms.

There are 17 executions needed to carry out the operation of procedures:
\mathring{1} Read the Directory/Folder Mode Flag DF.
\mathring{2} Read the frequency or web address of Current Channel XXX from memory as the channel to be played.
\mathring{3} Read Current Channel XXX, read the first folder code under XXX, write this folder code to Current Channel YYY and Cursor Position C.
\mathring{4} Select the frequency or web address from tuner or LAN module and pass the contents received to TV Display.
\mathring{5} Read the frequency or web address of Current Channel YYY under Current Channel XXX as the channel to be played. Write YYY to Cursor Position C.
\mathring{6} Increment Current Channel XXX by 1.
\mathring{7} Decrement Current Channel XXX by 1.
\mathring{8} If input is a single digit a, write 00a to XXX.
If input is a 2-digit aa, write 0aa to XXX.
If input is a 3-digit aaa, write aaa to XXX.
If input is of 4 or more digits aaaa . . . , write the first 3 digits aaa to XXX.
\mathring{9} Display folder code window of Current Channel XXX.
\mathring{10} Write input aaa . . . to Current Channel YYY and Cursor Position C.
\mathring{11} Emit an error message by a sound or beep.
\mathring{12} Match input aaa . . . with the folder codes under Current Channel XXX.
\mathring{13} Write “F” to Directory/Folder Mode Flag DF.
\mathring{14} Write “D” to Directory/Folder Mode Flag DF.
\mathring{15} Read the folder code next to the Current Channel YYY under Current Channel XXX, write it to Cursor Position C.
\mathring{16} Read the folder code previous to the Current Channel YYY under Current Channel XXX, write it to Cursor Position C.
\mathring{17} Write Cursor Position C to Current Channel YYY.

About the execution \mathring{9} “Display folder code window of Current Channel XXX”, further explanation and breakdown are needed. It is a series of executions by micro-processor to paste a window over the TV screen, showing the list of all folder code channels under current directory code with a cursor positioned on a selected folder code.

The details of this execution are:
1. Read Current Channel XXX.
2. Read all folder codes under Current Channel XXX.
3. Read Cursor Position C.
4. Execute graphic processing to make window image.
5. Output the window image to TV Display.
6. Start to count n seconds (n seconds is the duration time of this window on screen).
7. Write “Yes” to Window Show Up Flag W.
8. Stop output of window image to TV Display after n seconds counted.
9. Write “No” to Windows Show Up Flag W.
10. Write Current Channel YYY to Cursor Position C.

For each input, a procedure composed of executions is dedicated to processing it. There are 9 procedures needed to fulfill the operation of this system. In the following procedures, the circled numbers are the executions listed above and to be executed in the course of their text order. An end in parenthesis denotes the end of processing on this input.
1. When input is “Power”
If the power is on, then turn off the power (end).
If the power is off, then turn on the power, \mathring{5},
   If DF=D, then \mathring{2}, \mathring{3}, \mathring{4}, \mathring{9} (end)
   If DF=F, then \mathring{5}, \mathring{4}, \mathring{9} (end)
2. When input is “Channel Up”
\mathring{1}, if DF=D, then \mathring{6}, \mathring{3}, \mathring{2}, \mathring{4}, \mathring{9} (end)
   if DF=F, then \mathring{11} (end)
3. When input is “Channel Down”
\mathring{1}, if DF=D, then \mathring{7}, \mathring{3}, \mathring{2}, \mathring{4}, \mathring{9} (end)
   if DF=F, then \mathring{11} (end)
4. When input is “Display”
\mathring{9} (end)
5. When input is “aaa . . . ” (digits)
\mathring{2}, if DF=D and W=No, then \mathring{8}, \mathring{3}, \mathring{2}, \mathring{4}, \mathring{9} (end)
   if DF=D and W=Yes, then \mathring{12},
      if found, then \mathring{13}, \mathring{10}, \mathring{5}, \mathring{4}, \mathring{9} (end)
      if not found, then \mathring{11}, \mathring{9} (end)
   if DF=F, then \mathring{12},
      if found, then \mathring{10}, \mathring{5}, \mathring{4}, \mathring{9} (end)
      if not found, then \mathring{11}, \mathring{9} (end)
6. When input is “Back”
\mathring{14}, \mathring{2}, \mathring{3}, \mathring{4} (end)
7. When input is “Right” or “Up”
If (W=No and DF=F) or W=Yes, then \mathring{15}, \mathring{9} (end)
8. When input is “Left” or “Down”
If (W=No and DF=F) or W=Yes, then \mathring{16}, \mathring{9} (end)
9. When input is “Enter”
If DF=D and W=Yes, then \mathring{13}, \mathring{17}, \mathring{5}, \mathring{4}, \mathring{9} (end)
If DF=F and W=Yes, then \mathring{17}, \mathring{5}, \mathring{4}, \mathring{9} (end)

By the method described above, a 2-dimension channel coding system is able to take various channel sources, including wireless broadcasting, cabled broadcasting, and web system, and re-organize them by the 2-dimension access paths and sequence. It enhances TV user's convenience in channel identification and selection with existing TV control instruments. Therefore, this invention is innovative and of practical value, which meets the requirements and essence of a patent.

The implementation of this invention described above is not the only form possible. There may be modifications and deviations from this original one, though based on the same idea, design modules, method or applications described in this invention. All this modifications and organization applied in TV channel structure are within the scope claimed by this invention.

1. A 2-dimension channel coding system, taking signals inputed from various channel sources and re-organizing their access paths and sequence in a 2-dimension order to enhance TV user's convenience in channel identification and selection. It consists of:
an input receiver to take instructions sent from a TV remote controller operated by a TV user.
a micro-processor to process the instructions from input receiver based on the programs stored in the memory to make decision on TV channel selecting.
a memory module, which the data and programs needed for system operation are stored in, read from and written to.
a LAN module as signal receiver from web system or internet, and output to VGA display module for TV.
a tuner to receive broadcasting signals and output to VGA display module for TV.
a VGA display module for TV, which takes signals from tuner or LAN module, and then outputs to TV sets.

2. The 2-dimension channel coding system as described in 1, of which the 2-dimension channel organization consists of the directory code channels in the 1^{st} hierarchy and the folder code channels in the 2^{nd} hierarchy.

3. The 2-dimension channel coding system as described in 1, of which the input receiver is an IR (Infrared Rays) or RF (Radio Frequency) receiver.

4. The 2-dimension channel coding system as described in 1, of which the LAN module is a standard LAN chip or LAN card used in personal computer industry.

5. The 2-dimension channel coding system as described in 1, of which the VGA display module for TV takes signals from tuner or LAN module, and outputs to TV sets in the standard TV input interface with audio, video and super VHS terminals.

6. The 2-dimension channel coding system as described in 1, of which the memory module contains the data as follows:
(a) Operating system and execution programs.
(b) Directory code and folder code table, which is a database containing all information about the valid channels.
(c) Current Directory Code Channel XXX and Current Folder Code Channel YYY. They are parameters containing the code of currently played directory code channel and folder code channel respectively.
(d) Cursor Position C, a parameter containing the folder code on which a cursor is placed when a folder code window is shown.
(e) Directory/Folder Mode Flag DF, a parameter to indicate that the channel being played now is a directory code channel or a folder code channel.
(f) Window Show Up Flag W, a parameter to indicate if there is folder code window showing up in the TV screen.

7. The directory code and folder code table of the memory module as described in (b) of 6 contains the information as follows:
(a) All directory code channels and their frequencies at tuner or web address accessible through LAN module.
(b) All the folder code channels under every directory code channels.
(c) The frequency or web address of each folder code channel under a directory code.

8. A method to encode the TV channels in the 2-dimension order by re-organizing their access paths and sequence. The TV channels are arranged in 2 hierarchies, the directory code channels in the 1^{st} hierarchy of fixed number of digits denoting major channels, and the folder code channels in the 2^{nd} hierarchy of non-fixed number of digits denoting the sub-channels within a directory code channel.

9. The method to encode the TV channels in the 2-dimension order as described in 8, of which the directory code channels can be accessed by:
(a) using the “channel up” and “channel down” function of the remote controller when TV is playing a directory code channel.
(b) directly enter the directory code in digits when TV is playing a directory code channel.
(c) when TV is playing a folder code channel, use “back” function to return to its directory code channel and then perform (a) or (b) described in 10.

10. The method to encode the TV channels in the 2-dimension order as described in 8, of which a “window” shows up in TV screen to display the folder code channels for TV users selection if there are folder code channels within this directory code channel.

11. The method to encode the TV channels in the 2-dimension order as described in 8, of which the folder code channels can be accessed by:
(a) “Up”, “Down”, “Right”, and “Left” function followed by “Enter” function, when a folder code window is shown on the screen.
(b) When the TV is playing a folder code channel, directly entering the folder code under the same directory code.
(c) When TV is playing a directory code channel, only the folder code channels within this directory code channel can be selected by means of (a) or (b) described in 12.

12. The method to encode the TV channels in the 2-dimension order as described in 8, when the TV is playing a directory code channel, TV user has direct access to other directory code channels or the folder code channels within the currently played directory code channel.

13. The method to encode the TV channels in the 2-dimension order as described in 8 is applied on the currently existing TV systems.

14. The method to encode the TV channels in the 2-dimension order as described in 8 is able to take various channel sources including wireless broadcasting, cabled broadcasting, web system and internet and reorganize them as TV channels in 2 hierarchies denoted by the directory codes and the folder codes.
